(19) United States
(12) Patent Application Publication
(10) Pub. No.: US 2009/0282384 A1
(43) Pub. Date: Nov. 12, 2009

(54) Framework-Based Model-Driven Software Development

(75) Inventor: Peter A. Keppler, Bradenton, FL (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/463,691

(22) Filed: May 11, 2009

Related U.S. Application Data
(60) Provisional application No. 61/052,526, filed on May 12, 2008.

(51) Int. Cl. G06F 9/44

(52) U.S. Cl. 717/104; 717/106; 717/120

(57) ABSTRACT

In accordance with certain embodiments of the present invention, a method includes generating a platform independent software framework using a graphical modeling language. The platform independent software framework includes one or more platform independent components each describing a platform independent behavior common to each of a plurality of computing platforms and one or more platform specific components each corresponding to a platform specific plug-ins of a platform specific model. The platform specific model corresponds to one of the plurality of computing platforms. The method further includes generating, using the graphical modeling language, a particular platform specific model corresponding to a particular computing platform of the one or more computing platforms. The particular platform model includes one or more platform specific plug-ins each corresponding to a platform specific component of the platform independent framework and describing a platform specific behavior for the particular computing platform.

### RELATED APPLICATIONS

This application claims the benefit under 35 U.S.C. § 119(e) of the priority of U.S. Provisional Application 61/052,526, filed May 12, 2008, entitled “Software Development Architecture.”

### GOVERNMENT RIGHTS

This invention was made with U.S. Government support under Design Agent and Engineering Services contract number N00024-06-C-5101 FY06-08. The U.S. Government may have certain rights in this invention.

### TECHNICAL FIELD OF THE DISCLOSURE

This disclosure relates generally to software development and more particularly to framework-based model-driven software development.

### BACKGROUND

A software program generally includes a set of instructions (code) that may be executed on a computing system in an organized manner to produce one or more characteristic behaviors. To facilitate the creation of a software program having numerous lines of code, a software programmer may utilize a standardized modeling language that expresses information in a structure that is defined by a consistent set of rules. For example, a software programmer may utilize a graphical modeling language to create a diagram representing a software program, the diagram including named symbols that represent concepts, lines connecting the symbols that represent relationships, and various other graphical annotation that represent constraints. The software code to be executed on the computing system may then be generated based on the diagram using a code generation tool. The unified modeling language (UML) is one particular example of a graphical modeling language.

### SUMMARY

According to the present invention, disadvantages and problems associated with previous techniques for framework-based model-driven software development may be reduced or eliminated.

In accordance with certain embodiments of the present invention, a method includes generating a platform independent software framework using a graphical modeling language. The platform independent software framework includes one or more platform independent components each describing a platform independent behavior common to each of a plurality of computing platforms and one or more platform specific components each corresponding to a platform specific plug-ins of a platform specific model. The platform specific model corresponds to one of the plurality of computing platforms. The method further includes generating, using the graphical modeling language, a particular platform specific model corresponding to a particular computing platform of the one or more computing platforms. The particular platform model includes one or more platform specific plug-ins each corresponding to a platform specific component of the platform independent framework and describing a platform specific behavior for the particular computing platform.

Particular embodiments of the present invention may provide one or more technical advantages. For example, a product family may include a plurality of different computing platforms each operable to perform a common task. To facilitate the performance of the common task, a plurality of software programs may be needed, each software program corresponding to a particular computing platform and operable when executed to perform the common task. Furthermore, in order to perform the common task, each software program may need to perform behaviors common to each computing platform (platform independent behaviors) and behaviors specific to the computing platform to which the software program corresponds (platform specific behaviors).

Certain embodiments of the present invention may facilitate the generation of a platform independent software framework describing the platform independent behaviors common to each computing platform of the product family. Additionally, certain embodiments of the present invention may facilitate the generation of platform specific models comprising one or more platform specific plug-ins, each platform specific model describing platform specific behaviors for a particular computing platform of the product family. Software programs may be generated for each computing platform of the product family by incorporating (plugging-in) software code generated based on the platform specific plug-ins of each platform specific model into software code generated based on the common platform independent software framework. Generating software programs in this manner may eliminate redundancy in developing software for facilitating the performance of a common task for each of the computing platforms of a product family. As a result, certain embodiments of the present invention may reduce the overall time and cost associated with developing software for facilitating the performance of a common task for each of the computing platforms of a product family.

Certain embodiments of the present invention may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram representative of a software development architecture for generating a software code using framework-based model-driven software development, according to certain embodiments of the present invention;

FIG. 2 illustrates an example software development system for generating software code using framework-based model-driven software development, according to certain embodiments of the present invention;

FIG. 3 illustrates an example method for generating a software code using framework-based model-driven software development, according to certain embodiments of the present invention;

FIG. 4 illustrates an approach to transferring data between platform specific components of a platform independent framework and platform specific plug-ins of a platform specific model, according to certain embodiments of the present invention;

FIG. 5 illustrates an approach to implementing a platform independent software framework, according to certain embodiments of the present invention; and

FIGS. 6A and 6B illustrate screenshots of an example software development application/code generation tool, according to certain embodiments of the present invention.

### DESCRIPTION OF EXAMPLE EMBODIMENTS

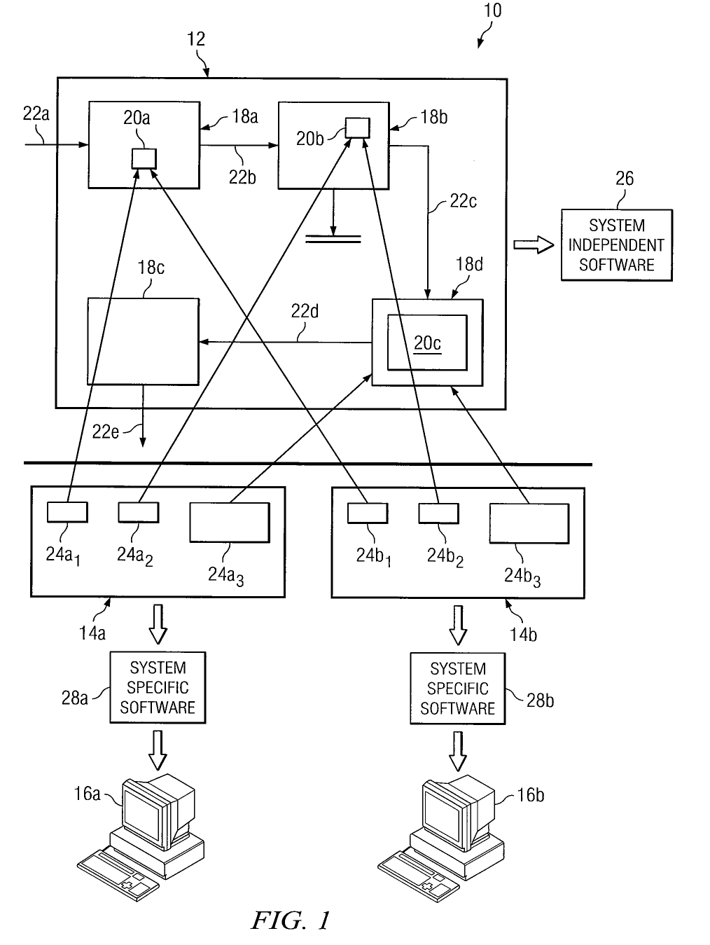

Embodiments of the present invention and its advantages are best understood by referring to FIGS. 1 through 6B of the drawings, like numerals being used for like and corresponding parts of the various drawings.

FIG. 1 illustrates a block diagram representative of a software development architecture 10 for generating a software code using framework-based model-driven software development, according to certain embodiments of the present invention. Software development architecture 10 generally comprises a platform independent framework 12 and one or more platform specific models 14 (14a, b).

Software development architecture 10 generally describes behaviors to be performed by one or more products (e.g., computing platforms 16) of a particular product family such that each product of the product family may perform a common task. A product family may include any type and number of computing platforms 16 (16a, b) that share a common task (i.e., have at least one behavior in common with one another). Computing platforms 16 may include any suitable combination of hardware, firmware, and/or software.

Certain behaviors to be performed by the one or more products may be the same regardless of the product (platform independent behaviors). In some cases, certain products of a particular product family may be dissimilar, so certain behaviors to be performed by the products may differ depending on the product (platform specific behaviors). The platform independent behaviors may be described by platform independent framework 12 of software development architecture 10, and the platform specific behaviors of a particular product may be described by the platform specific model 14 of the particular product.

As a particular example, in the national defense context, a product family may include a number of different radar platforms (i.e., computing platforms 16), each located on particular vehicle (e.g., Navy ships and aircraft). Each vehicle's radar platform may produce a radar picture of a different location of a battlefield. The radar pictures may be aggregated such that each vehicle may view a composite radar image of the entire battlefield. The aggregation of the radar pictures is a common task to be performed by each of the radar platforms, and this common task may be represented by software development architecture 10. Furthermore, each of the radar platforms may need to perform a number of behaviors in order to achieve the desired aggregation, and certain of the behaviors may be the same regardless of the radar platform, that is, the behaviors may be platform independent behaviors described by platform independent framework 12. Some of the radar platforms of the product family may be dissimilar, so certain behaviors may differ depending on the radar platform, that is, the behaviors may be platform dependent behaviors described by the a platform specific model 14 associated with each radar platform.

As an additional particular example, a product family may include a number of cellular telephones (i.e., computing platforms 16), each manufactured by a different manufacturer. Each of the cellular telephones may have the same core features, such as call setup, speed dial, transmission frequency, call forwarding, video-on-demand, text messaging, and the like. These core features performed by the cellular telephones (performed in the aggregate or individually) may be considered a common task that may be represented by software development architecture 10. Furthermore, each cellular telephone may need to perform a number of behaviors in order to achieve the core features, and certain of the behaviors may be the same regardless of the cellular telephone manufacturer, that is, the behaviors may be platform independent behaviors described by platform independent framework 12. Each of the cellular telephone manufacturer may include different hardware and/or software in their cellular telephones, so certain behaviors may differ depending on the cellular telephone manufacturer, that is, the behaviors may be platform dependent behaviors described by the a platform specific model 14 associated with each radar platform.

Referring back to FIG. 1, platform independent framework 12 of software development architecture 10 may include one or more platform independent components 18 (18a, b, c, d), one or more platform specific components 20 (20a, b, c), and one or more communication paths 22 (22a, b, c, d, e). A component (e.g., platform independent components 18 and platform specific components 20) may be any modular, self-sufficient, replaceable unit of the platform independent framework 12. In certain embodiments, platform independent framework 12 may correspond to (e.g., represent the behaviors of) a system for performing a common task on each computing platform 16 of a product family, and each component (e.g., platform independent components 18 and platform specific components 20) of platform independent framework 12 may correspond to (e.g., represent the behaviors of) a sub-system for performing a particular behavior to achieve the performance of the common task. Similarly, platform independent framework 12 may correspond to (e.g., represent the behaviors of) a sub-system for performing a portion of a common task on each computing platform 16 of a product family, and each component (e.g., platform independent components 18 and platform specific components 20) of platform independent framework 12 may correspond to (e.g., represent the behaviors of) a sub-sub-system for performing a particular behavior to achieve the performance of the portion of common task. Thus, by adding additional components (e.g., platform independent components 18 and/or platform specific components 20) to a platform independent framework 12 and/or combining a platform independent framework 12 with one or more other platform independent frameworks 12, additional functionality may be achieved without generating a new platform independent framework 12.

Platform independent components 18 may represent behaviors common to each computing platform 16 of a particular product family (platform independent behaviors). Platform specific components 20 may correspond to behaviors specific to a particular computing platform 16 of the product family (platform specific behaviors). Each platform specific model 14 of software development architecture 10 may include one or more platform specific plug-ins 24 (24a₁, a₂, a₃, b₁, b₂, b₃), each describing a behavior specific to the computing platform 16 with which the platform specific model 14 is associated. Platform specific components 20 may each correspond to a particular platform specific plug-in 24 of a particular platform specific model 14, the particular platform specific plug-in 24 describing a behavior specific to the computing system 16 with which the particular platform specific model 14 is associated.

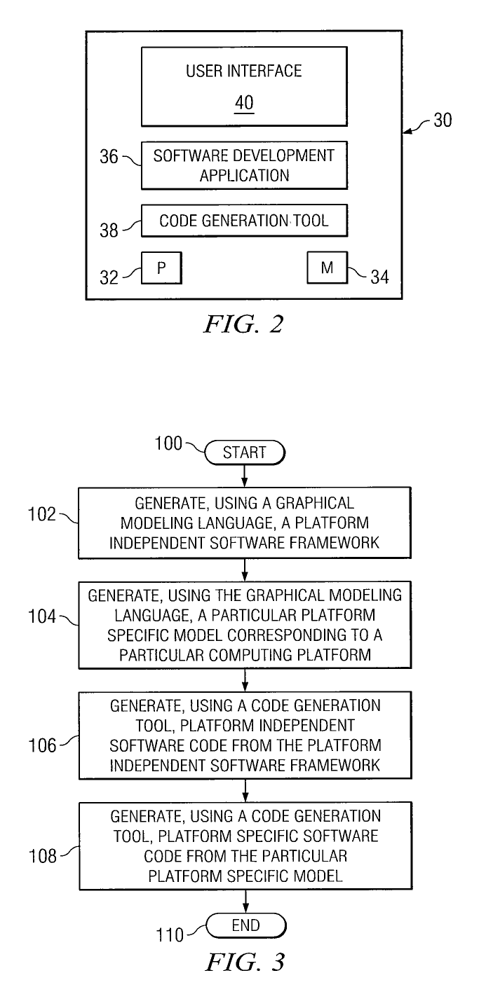

Once the platform independent framework 12 and one or more platform specific models have been defined, a code generation tool (e.g., code generation tool 38, described in further detail with reference to FIG. 2) may be used to generate system independent software code 26 and system specific software code 28 (28a, b) from platform independent framework 12 and platform specific framework 14, respectively.

Platform independent framework 12 and platform specific models 14 may include any type of notational model that may be converted to executable software code by a code generation tool. In certain embodiments, platform independent framework 12 and platform specific models 14 may be designed according to object oriented principles. As a particular example, platform independent framework 12 and platform specific models 14 may conform to the unified modeling language (UML) 2.0 specification, which provides an object oriented description of software written in various languages, such as C++, Java, or Ada. In other words, the UML 2.0 specification is a graphical modeling language specifying the format of objects and their interaction with one another that provides one approach to organizing objects used for construction of computer executable software in a systematic and organized manner.

Components of platform independent framework 12 (e.g., platform independent components 18 and platform specific components 20) and platform specific plug-ins 24 of platform specific model 14 may be expressed as a set of abstract classes and the way their instances collaborate for a specific type of software. Platform independent framework 12 and platform specific models 14 may include support programs, code libraries, a scripting language, or other software to help develop and bind the different components of a software project together. Various portions of platform independent framework 12 and platform specific models 14 may be exposed through an application programming interface (API).

In particular embodiments, platform independent framework 12 and platform specific models 14 conform to the unified modeling language (UML) 2.0 specification. In these embodiments, platform specific components 20 of platform independent framework 12 may be expressed as a set of parent classes, and the platform specific plug-ins of a platform specific model 14 may be expressed as a set of child classes that inherit common behaviors and/or data a particular parent class (platform specific components 20 of platform independent framework 12). As a particular example, platform specific components 20a of platform independent framework 12 may be expressed as a parent classes, and platform specific plug-in 24a₃ of platform specific model 14a may be expressed as a child class that inherits common behaviors and/or data from the platform specific components 20a parent class.

The generated system independent software 26 (generated based on the platform independent framework 12) may be executed on any of the computing platforms 16 of a product family (e.g., either computing platform 16a or computing platform 16b), the system independent software 26 operable when executed to perform the platform independent behaviors described by the platform independent framework 12. Furthermore, the system independent software 26 may be operable when executed on a particular computing platform 16 (e.g., computing platform 16a) to instantiate the appropriate system specific software 28 (e.g., system specific software 28a). In certain embodiments, the system independent software 26 may be operable when executed on a particular computing platform 16 (e.g., computing platform 16a) to instantiate the appropriate system specific software 28 (e.g., system specific software 28a) by distinguishing the appropriate system specific software 28 from other system specific software 28 (e.g., system specific software 28b) stored in a database. Once instantiated by the system independent software 26, the system specific software 28 may be executed and operable when executed to perform the platform specific behaviors described by the platform specific model 14.

In certain embodiments, the platform independent software code 26 generated based on the platform independent framework 12 of software development architecture 10 is reusable (i.e., it can be executed on each computing platform 16 of a product family), so software development architecture 10 may reduce software development redundancies (such as reducing development time and cost) associated with the development of software code for performing a common task on each of a number of computing platforms 16 of a product family.

Although FIG. 1 illustrates a particular development architecture 10 that includes particular components that are each configured to provide certain functionality, alternative embodiments may include any appropriate combination of components having the described functionality divided between the components in any suitable manner.

FIG. 2 illustrates an example software development system for generating software code using framework-based model-driven software development, according to certain embodiments of the present invention. Software development system 30 may include one or more computer systems operating at one or more locations. The one or more computer systems may include any appropriate input devices (such as a keypad, touch screen, mouse, or other device that can accept information), output devices, mass storage media, or other suitable components for receiving, processing, storing, and communicating data. Software development system 30 may include a personal computer, workstation, network computer, kiosk, wireless data port, personal data assistant (PDA), one or more processors within these or other devices, or any other suitable processing device.

Software development system 30 may include a processing module 32, a memory module 34, a software development application 36, a code generation tool 38, and a user interface 40. Although certain functionality is described below as being associated with either software development application 36 or code generation tool 38, certain embodiments contemplate the functionality being combined or separated among software development application 36 and code generation tool 38, or any other suitable component in any suitable manner, according to particular needs. Furthermore, software development system 30 may include any suitable combination of hardware, firmware, and/or software.

Processing module 32 may include one or more microprocessors, controllers, or any other suitable computing devices or resources. Processing module 32 may work, either alone or with other components of software development system 30, to provide the functionality described herein. Memory module 34 may take the form of volatile or non-volatile memory including, without limitation, magnetic media, optical media, random access memory (RAM), read only memory (ROM), removable media, or any other suitable memory component.

Software development application 36 of software development system 30 may include any suitable application for developing software according to model driven development (MDD) principles. For example, software development application 36 may be an the application marketed by IBM CORPORATION under the trade name RHAPSODY.

Software development application 36 of software development system 30 may be used (e.g., by a user of software development system 30, such as a computer programmer) to generate a platform independent framework 12. The generated platform independent framework may include one or more platform independent components 18, each describing a platform independent behavior common to each of a plurality of computing platforms 16 of a product family. The generated platform independent framework 12 may also include one or more platform specific components 20 each corresponding to a platform specific plug-in 24 of a platform specific model 14.

Software development application 36 of software development system 30 may be used (e.g., by a user of software development system 30, such as a computer programmer) to generate a particular platform specific model 14 corresponding to a particular computing platform 16 of the product family. The generated platform specific model may include one or more platform specific plug-ins 24 each describing a platform specific behavior of the particular computing platform 16, and each platform specific plug-ins 24 may correspond to a platform specific component 20 of the platform independent framework 12.

Code generation tool 38 of software development system 30 may include any suitable tool that generates software according to model driven development (MDD) principles. For example, code generation tool 38 may be a tool marketed by IBM CORPORATION under the trade name RHAPSODY.

Code generation tool 38 may be operable to generate platform independent software code based on platform independent framework 12. Additionally, code generation tool 38 may be operable to generate platform specific software code based on platform specific model 14.

Although FIG. 2 illustrates a particular software development system 30 that includes particular components that are each configured to provide certain functionality, alternative embodiments may include any appropriate combination of components having the described functionality divided between the components in any suitable manner.

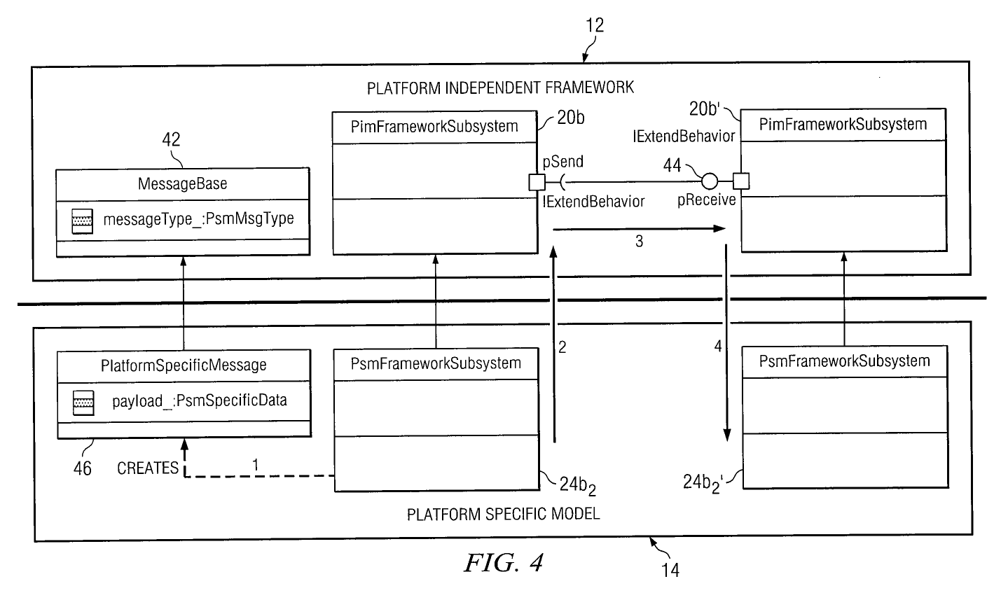

FIG. 3 illustrates an example method for generating software using framework-based model-driven software development, according to certain embodiments of the present invention. The method begins at step 100. At step 102, a platform independent framework 12 is generated, using a graphical modeling language, by software development application 36 of software development system 30. The generated platform independent framework 12 may include one or more platform independent components 18 each describing a platform independent behavior common to each of a plurality of computing platforms of a product family. The generated platform independent software framework may also include one or more platform specific components 20 each corresponding to a platform specific plug-in 24 of a platform specific model 14, the platform specific model 14 corresponding to one of the plurality of computing platforms 16 of a product family. In certain embodiments, platform independent framework 12 is generated using a modeling language that complies with the UML 2.0 specification.

At step 104, a particular platform specific model 14 corresponding to a particular computing platform 16 is generated, using the graphical modeling language, by software development application 36 of software development system 30. The particular platform specific model 14 may include one or more platform specific plug-ins 24 each corresponding to a platform specific component 18 of the platform independent framework 12. Furthermore, each platform specific plug-in 24 may describe a platform specific behavior for the particular computing platform 16 to which the particular platform specific model 14 corresponds. In certain embodiments, platform independent framework 12 is generated using a modeling language that complies with the UML 2.0 specification.

At step 106, platform independent software code is generated by code generation tool 38 based on platform independent framework 12. At step 108, platform specific software code is generated by code generation tool 38 based on platform specific model 14. The generated platform independent software code, when executed on the particular computing platform 16, may be operable to instantiate the system specific software code such that the system specific software code can be executed on the particular computing platform 16.

Modifications, additions, or omissions may be made to the method without departing from the scope of the invention. The method may include more, fewer, or other steps. Additionally, steps may be performed in any suitable order without departing from the scope of the invention.

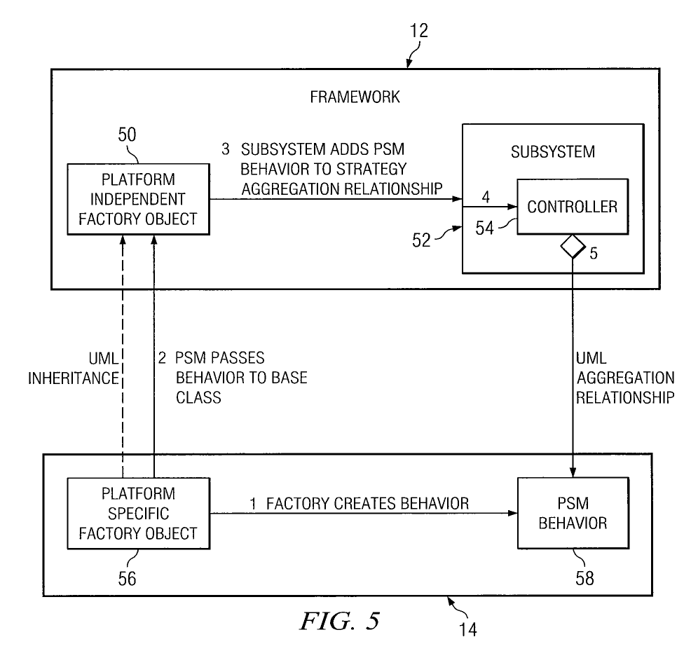

FIG. 4 illustrates an approach to transferring data between platform specific components 20 of platform independent framework 12 and platform specific plug-ins 24b of platform specific model 14b. Platform independent framework 12 includes a message base class 42 describing interfaces that pass abstract data types through platform independent framework 12 to platform specific model 14. Message base class 42 provides synchronous or asynchronous data transferal using procedure calls or by passing events through ports configured between platform dependent component 20b of platform independent framework 12 and platform specific plug-in 24b₂ of platform specific model 14b (which corresponds to computing platform 16b). Message base class 42 may also supply the contracts for the ports 44 of the platform dependent component 20b.

To transmit a message, platform specific plug-in 24b₂ instantiates a specific message object 46 that inherits from message base class 42 and populates specific message object 46 with data. Specific message object 46 is then passed from platform specific plug-in 24b₂ to platform dependent component 20b. Data in specific message object 46 is then sent as an abstract data type to another platform dependent component 20b′ responsible for handling the data. The other platform dependent component 20b′ processes the data and passes the abstract data to a corresponding platform specific plug-in 24b₂′, which casts the abstract data type to a format suitable for use by its associated computing system 16b.

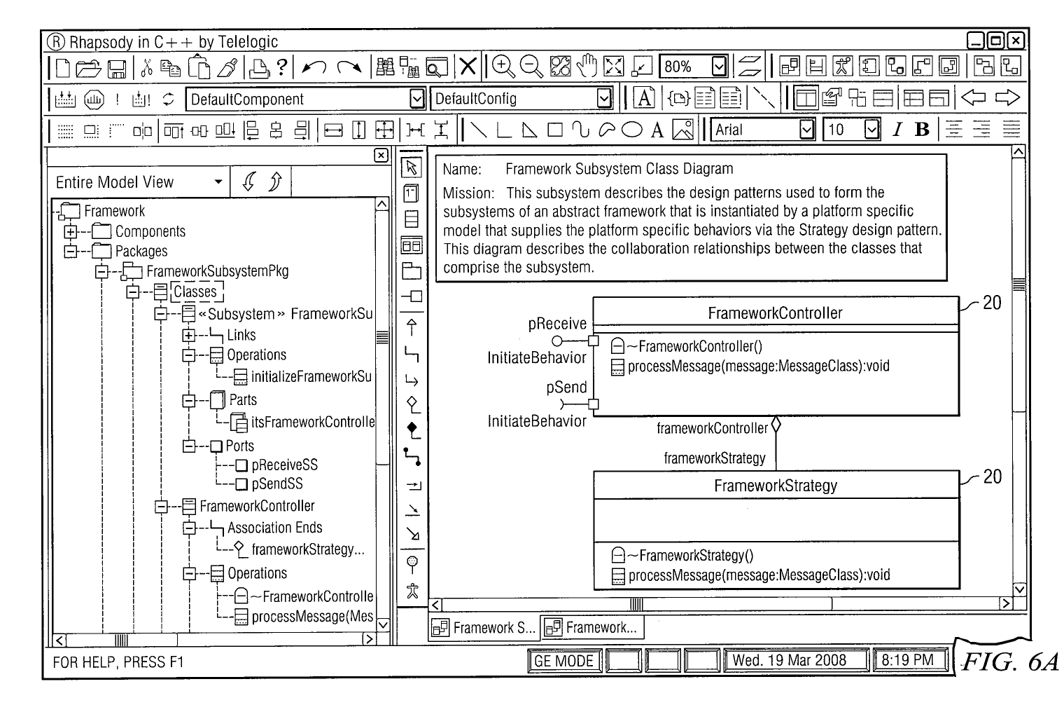

FIG. 5 illustrates an example approach to implementing a software development architecture 10, according to certain embodiments of the present invention. Platform independent framework 12 includes a platform independent factory object 50 and one or more one or more platform independent subsystem objects 52 that each have a controller object 54. Platform specific model 14 includes a platform specific factory object 56 and one or more platform specific subsystem objects 58.

When executed by its associated computing platform 16 (e.g., computing platform 16a), system independent software 26 launches system specific software 28 (e.g., system specific software 28a) in which platform specific framework factory object 56 constructs an inheritance association with platform independent factory object 50. That is, platform specific factory object 56 inherits the behavior and other associated attributes of platform independent factory object 50.

Platform specific factory object 56 also instantiates one or more platform specific subsystem objects 58 describing one or more platform specific behaviors of the associated computing platform 16 (e.g. computing platform 16a). Upon instantiation of a platform specific subsystem object 58, platform dependent factory object 56 passes the platform specific subsystem object 58 to a platform independent factory object 50. The platform independent factory object 50 then passes the platform specific subsystem object 58 to the corresponding instance of platform independent object 52, which passes the platform specific subsystem object 58 to platform independent object 54 to set the aggregation relationship with it's associated platform specific system object 58. This aggregation relationship may provide various forms of communication, such as message translation and/or control sequence translation, between computing system 16 and platform independent framework 12.

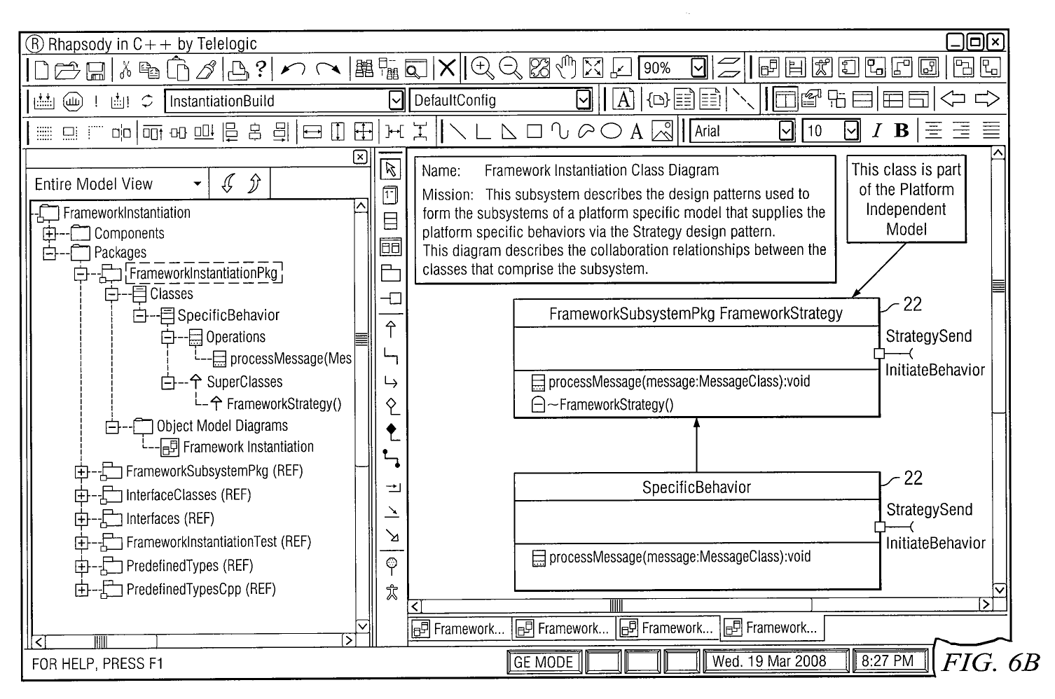

FIGS. 6A and 6B illustrate screenshots of an example software development application 36/code generation tool 38, according to certain embodiments of the present invention. The illustrated software development application 36/code generation tool 38 is provided by IBM CORPORATION and marketed under the trade name RHAPSODY. However, any suitable software development application 36 suitable for developing software according to model driven development (MDD) principles and any code generation tool 38 that generates software according to model driven development (MDD) principles may be used.

FIG. 6A illustrates a screenshot showing various objects of platform independent framework 12 (e.g., platform independent components 18 and/or platform specific components 20) that may be created by code generation tool 38.

FIG. 6B illustrates a screenshot showing several platform specific objects (i.e., platform specific plug-ins 24) of platform specific framework 14. In this particular example, the platform specific framework 14 is generated independent of platform independent framework 12. In this manner, additional platform specific frameworks 14 may be generated for additional computing platforms 16 of a product family without affecting platform independent framework 12 to an undue degree. Generating platform specific framework 14 independent of platform independent framework 12 may also allow for modifications to platform independent framework 12 without affecting the platform specific models 14 corresponding to each of the computing platforms 16 of the product family.

In certain embodiments, platform independent framework 12 is added to the platform specific framework 14 “by reference.” In other words, platform independent framework 12 is provided in this view in a “read only” mode such that platform independent framework 12 may be visible and usable, yet free from inadvertent modification. Visibility of objects of platform independent framework 12 (e.g., platform independent components 18 and/or platform specific components 20) may be “dragged and dropped” onto platform specific framework 14 such that unified UML relationships can be drawn to them.

Although the present invention has been described with several embodiments, diverse changes, substitutions, variations, alterations, and modifications may be suggested to one skilled in the art. It is intended that the invention encompass all such changes, substitutions, variations, alterations, and modifications as fall within the spirit and scope of the appended claims.

What is claimed is:

1. A method, comprising:
generating, using a graphical modeling language, a platform independent software framework comprising:
one or more platform independent components each describing a platform independent behavior common to each of a plurality of computing platforms; and
one or more platform specific components each corresponding to a platform specific plug-in of a platform specific model, the platform specific model corresponding to one of the plurality of computing platforms; and
generating, using the graphical modeling language, a particular platform specific model corresponding to a particular computing platform of the one or more computing platforms, the particular platform model comprising one or more platform specific plug-ins each corresponding to a platform specific component of the platform independent framework and describing a platform specific behavior for the particular computing platform.

2. The method of claim 1, the graphical modeling language comprising a language that conforms to the Unified Modeling Language (UML) 2.0 specification.

3. The method of claim 1:
each of the one or more platform independent components comprising a class;
each of the one or more platform specific components comprising a parent class; and
each of the one or more platform specific plug-ins of the particular platform specific model comprising a child class corresponding to a particular parent class.

4. The method of claim 1, comprising:
generating, using a code generation tool, platform independent software code from the platform independent software framework; and
generating, using the code generation tool, platform specific software code from the particular platform specific model.

5. The method of claim 1, comprising:
generating, using a code generation tool, platform independent software code from the platform independent software framework, the platform independent software code operable when executed on the particular computing platform to instantiate platform specific software code such that the platform specific software code is executed on the particular computing platform.

6. The method of claim 1, comprising:
generating, using a code generation tool, platform specific software code from the particular platform specific model, the platform specific software code operable, prior to being executed on the particular computing platform, to instantiate platform independent software code.

7. A computer-readable media encoded with logic, the logic operable when executed to perform operations comprising:
generating, using a graphical modeling language, a platform independent software framework comprising:
one or more platform independent components each describing a platform independent behavior common to each of a plurality of computing platforms; and
one or more platform specific components each corresponding to a platform specific plug-in of a platform specific model, the platform specific model corresponding to one of the plurality of computing platforms; and
generating, using the graphical modeling language, a particular platform specific model corresponding to a particular computing platform of the one or more computing platforms, the particular platform model comprising one or more platform specific plug-ins each corresponding to a platform specific component of the platform independent framework and describing a platform specific behavior for the particular computing platform.

8. The computer-readable media of claim 7, the graphical modeling language comprising a language that conforms to the Unified Modeling Language (UML) 2.0 specification.

9. The computer-readable media of claim 7:
each of the one or more platform independent components comprising a class;
each of the one or more platform specific components comprising a parent class; and
each of the one or more platform specific plug-ins of the particular platform specific model comprising a child class corresponding to a particular parent class.

10. The computer-readable media of claim 7, the logic operable when executed to perform operations comprising:
generating platform independent software code from the platform independent software framework; and
generating platform specific software code from the particular platform specific model.

11. The computer-readable media of claim 7, the logic operable when executed to perform operations comprising:
generating platform independent software code from the platform independent software framework, the platform independent software code operable when executed on the particular computing platform to instantiate platform specific software code such that the platform specific software code is executed on the particular computing platform.

12. The computer-readable media of claim 7, the logic operable when executed to perform operations comprising:
generating platform specific software code from the particular platform specific model, the platform specific software code operable, prior to being executed on the particular computing platform, to instantiate platform independent software code.

13. A system, comprising:
one or more processing units operable to:
generate, using a graphical modeling language, a platform independent software framework comprising:
one or more platform independent components each describing a platform independent behavior common to each of a plurality of computing platforms; and
one or more platform specific components each corresponding to a platform specific plug-in of a platform specific model, the platform specific model corresponding to one of the plurality of computing platforms; and
generate, using the graphical modeling language, a particular platform specific model corresponding to a particular computing platform of the one or more computing platforms, the particular platform model comprising one or more platform specific plug-ins each corresponding to a platform specific component of the platform independent framework and describing a platform specific behavior for the particular computing platform.

14. The system of claim 13, the graphical modeling language comprises a language that conforms to the Unified Modeling Language (UML) 2.0 specification.

15. The system of claim 13:
each of the one or more platform independent components comprising a class;
each of the one or more platform specific components comprising a parent class; and
each of the one or more platform specific plug-ins of the particular platform specific model comprising a child class corresponding to a particular parent class.

16. The system of claim 13, the one or more processing units operable to:
generate platform independent software code from the platform independent software framework; and
generate platform specific software code from the particular platform specific model.

17. The system of claim 13, the one or more processing units operable to:
generate platform independent software code from the platform independent software framework, the platform independent software code operable when executed on the particular computing platform to instantiate platform specific software code such that the platform specific software code is executed on the particular computing platform.

18. The system of claim 13, the one or more processing units operable to:
generate platform specific software code from the particular platform specific model, the platform specific software code operable, prior to being executed on the particular computing platform, to instantiate platform independent software code.
